(19) United States
(12) Patent Application Publication
(10) Pub. No.: US 2026/0111772 A1
(43) Pub. Date: Apr. 23, 2026

(54) ACTION SYNCHRONIZATION VIA ENTANGLED PARTICLE PAIRS

(71) Applicant: International Business Machines Corporation, Armonk, NY (US)

(72) Inventors: John Stern Alexander, Hampstead, NC (US); Steven Lee Fisher-Stawinski, Buffalo Grove, IL (US); Charles Palmer, Hanover, NH (US)

(21) Appl. No.: 18/919,204

(22) Filed: Oct. 17, 2024

(51) Int. Cl. G06N 10/00

(52) U.S. Cl. CPC G06N 10/00

(57) ABSTRACT

A method, according to one approach, includes receiving, by a first recipient at a first location, a first portion of a prepared stream of entangled particle pairs, where the first portion includes a first particle of a first of the entangled particle pairs and a first particle of a second of the entangled particle pairs. The method further includes detecting first measurement results of the first particle of the first entangled particle pair and first measurement results of the first particle of the second entangled particle pair. The method further includes identifying, within a predetermined playbook of the first recipient, a first entry that is associated with the first measurement results of the first particle of the first entangled particle pair and the first measurement results of the first particle of the second entangled particle pair. A first action paired with the first entry is performed by the first recipient.

### BACKGROUND

The present invention relates to quantum physics, and more specifically, this invention relates to using quantum physics for communication.

As exploration of outer space broadens (the distance between Earth and a space exploring craft increases) space technology faces a multitude of challenges and issues that remain to be resolved. Some of these challenges and issues are based on the coordination of activities by parties who are separated by relatively large distances, e.g., distances measured in terms of light-seconds and greater. Conventional solutions to these issues experience delay times equal to two times the light-distance between the communicating parties, e.g., an Earth based ground station and a space exploration craft.

### SUMMARY

A method, according to one approach, includes receiving, by a first recipient at a first location, a first portion of a prepared stream of entangled particle pairs, where the first portion includes a first particle of a first of the entangled particle pairs and a first particle of a second of the entangled particle pairs. The method further includes detecting first measurement results of the first particle of the first entangled particle pair and first measurement results of the first particle of the second entangled particle pair. The method further includes identifying, within a predetermined playbook of the first recipient, a first entry that is associated with the first measurement results of the first particle of the first entangled particle pair and the first measurement results of the first particle of the second entangled particle pair. A first action paired with the first entry is performed by the first recipient.

A computer program product, according to another approach, includes one or more computer-readable storage media, and program instructions stored on the one or more storage media to perform any combination of features of the foregoing methodology.

A computer system, according to another approach, includes a processor set, one or more computer-readable storage media, and program instructions stored on the one or more storage media to cause the processor set to perform any combination of features of the foregoing methodology.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3 is a flowchart of a method, in accordance with one approach of the present invention.

FIGS. 4A-4D depict a communication environment, in accordance with several approaches of the present invention.

FIGS. 5A-5B depict tables of playbooks, in accordance with several approaches of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for action synchronization via entangled particle pairs.

In one general approach, a method includes receiving, by a first recipient at a first location, a first portion of a prepared stream of entangled particle pairs, where the first portion includes a first particle of a first of the entangled particle pairs and a first particle of a second of the entangled particle pairs. The method further includes detecting first measurement results of the first particle of the first entangled particle pair and first measurement results of the first particle of the second entangled particle pair. The method further includes identifying, within a predetermined playbook of the first recipient, a first entry that is associated with the first measurement results of the first particle of the first entangled particle pair and the first measurement results of the first particle of the second entangled particle pair. A first action paired with the first entry is performed by the first recipient.

A technical effect of using entangled particles of a prepared stream of entangled particle pairs to identify an action for a recipient to perform includes mitigating the occurrence of lag within communication across relatively large distances. More specifically, the use of entangled particles of a prepared stream of entangled particle pairs avoids light-lag over these relatively large distances. Within the context of LEO satellites, these technical effects mitigate light lag across distances of around 1200 kilometers (km), which otherwise amounts to a lag time of about 0.004 seconds. Within the context of distances between Earth and Earth's moon, these technical effects mitigate light lag across distances of around 356,500 km to 406,700 km, which otherwise amounts to a lag time of about 1.189 to 1.356 seconds. Furthermore, within the context of distances between Earth and Mars, these technical effects mitigate light lag across distances of around 54.6M km-401M km, which otherwise amounts to a lag time of about 3.03 minutes to 22.3 minutes. These technical effects further includes secured communications in that the system has no knowledge of what is contained in playbook pairs, which ultimately allows synchronization to be offered as a service. Yet furthermore, a technical effect of using entangled particles of a prepared stream of entangled particle pairs to identify an action for a recipient to perform includes communication across relatively large distances without a dependance on an atomic clock. More specifically, by not depending on an atomic clock, delays and errors that would otherwise be present (based on an accuracy of a given atomic clock changing based on nearby relatively large masses) are mitigated from communication transmission operations.

A second particle of the first entangled particle pair may be received by a second recipient at a second location, and a second particle of the second entangled particle pair may be received by the second recipient at the second location. The first action may include waiting to receive a transmission from the second recipient to cause a synchronous transaction between the first recipient and the second recipient.

A technical effect of a first recipient waiting to receive a transmission from a second recipient includes the enablement of a synchronous transaction between recipients that are separated by relatively large distances.

A predetermined playbook of the second recipient may include a second entry that is associated with first measurement results of the second particle of the first entangled particle pair and first measurement results of the second particle of the second entangled particle pair. A second action to be performed by the second recipient may be paired with the second entry, where the second action may include the second recipient transmitting the transmission to the first recipient.

A technical effect of causing different recipients to use different predetermined playbooks includes the enablement of a synchronous transaction between recipients that are separated by relatively large distances. More specifically, by having different predetermined playbooks, different but synchronous actions are performed by different recipients based on measurement results of the particles of an entangled particle pair matching. These different synchronous actions amount to a synchronous communication operation.

The identifying, within the predetermined playbook of the first recipient, the first entry that is associated with the first measurement results of the first particle of the first entangled particle pair and the first measurement results of the first particle of the second entangled particle pair may include measuring an orientation of the first particle of the first entangled particle pair, measuring an orientation of the first particle of the second entangled particle pair, and performing a lookup within the predetermined playbook of the first recipient for an entry pre-associated with orientations that match the measured orientations of the first particle of the first entangled particle pair and the first particle of the second entangled particle pair.

A technical effect of measuring orientations of particles of an entangled particle pair includes the facilitation of synchronized communication operations between recipients of the particles. In order to enable these synchronized communication operations, in some approaches, actions may be pre-paired with at least one entry within a predetermined playbook. This way, in some approaches, once an entry in the predetermined playbook is identified, an action paired with the identified entry may also be identified and performed knowing that a second recipient, that measures a second particle of the entangled particle pair is also performing an action to establish the synchronized communication operation.

The first action may also be paired with a second entry within the predetermined playbook of the first recipient, where the second entry within the predetermined playbook of the first recipient is not associated with the first measurement results of the first particle of the first entangled particle pair and the first measurement results of the first particle of the second entangled particle pair. The second entry within the predetermined playbook of the first recipient may not be associated with second measurement results of the first particle of the first entangled particle pair and second measurement results of the first particle of the second entangled particle pair.

A technical effect of pairing an action with multiple entries in a predetermined playbook includes increasing a probability that the given action is performed. More specifically, because the orientation of the particles of the first entangled particle pair cannot be controlled, pairing the first action to multiple different measurement results increases a probability that the first action is performed.

A second action may be paired with the first entry, where the second action may include one or more of syncing to a local time signal, auditing statuses of equipment of the first recipient, and generating a report. The method may further include performing, by the first recipient, the second action paired with the first entry.

A technical effect of using a predetermined playbook with a plurality of different actions includes a diversification of the potential synchronized operations that are able to be performed between different recipients across relatively large distances. A technical effect of pairing multiple actions with a given entry includes increasing an output of the recipient for each particle of an entangled particle pair that is processed.

The method may further include receiving, by the first recipient, the predetermined playbook of the first recipient, and in response to receiving the predetermined playbook of the first recipient, monitoring for entangled particles. In some approaches, the first location lies along an orbital path of the first recipient around a planet.

A technical effect of receiving playbook(s) and thereafter monitoring for prepared streams of entangled particle pairs includes the enablement of coordinated communication between recipients of the playbooks(s). More specifically, in approaches in which a location of the recipients is in different portions of outer space, a technical effect of receiving and using the playbook(s) includes a mitigation of delays in communication across relatively large distances, e.g., distances measured in terms of light-minutes and greater.

The first location may include interstellar space, a surface of a planet, and Earth's atmosphere, where the prepared stream of entangled particle pairs may be prepared on and transmitted by a spacecraft in outer space.

A technical effect of entangled particles being transmitted to and used by different devices across relatively large distances in space includes the enablement of coordinated communication throughout space, with minimal delays. Furthermore, for approaches in which the transmitter of the prepared stream (the spacecraft) is located between the recipients, delays associated with establishing communication between the recipients are further reduced as the entangled particle transmissions reach the recipients relatively quicker than the case in which the transmitter is not located between the recipients.

The method may further include determining whether a predetermined sequence of measurement results is detected, where a first of the predetermined sequence of measurement results may include the first measurement results of the first particle of the first entangled particle pair and the first measurement results of the first particle of the second entangled particle pair. The first entry may be identified within the predetermined playbook of the first recipient in response to a determination that the first predetermined sequence of measurement results has been detected.

A technical effect of conditionally triggering use of a predetermined playbook based on a predetermined sequence of measurement results being obtained includes reducing a processing workload of the first recipient. More specifically, the predetermined playbook of the first recipient is not prematurely analyzed by the first recipient subsequent to receiving a single entangled particle of an entangled particle pair. Instead, a scope of entries is first defined by identification of a predetermined sequence to reduce a scope of the entries of the predetermined playbook of the first recipient that is analyzed.

The method may further include tuning a likelihood that the first entry is identified within the predetermined playbook of the first recipient. Tuning the likelihood that the first entry is identified within the predetermined playbook of the first recipient may include adjusting, within the predetermined playbook of the first recipient, a number of measurement results that are associated with the first entry.

A technical effect of adjusting a length of one or more of the predetermined sequences includes tuning the likelihood and/or frequency of the playbook being triggered. Furthermore, increasing a length of the predetermined sequences allows for additional unique entries to be added to the playbook.

In another general approach, a computer program product includes one or more computer-readable storage media, and program instructions stored on the one or more storage media to perform any combination of features of the foregoing methodology. Similar technical effects are obtained.

In another general approach, a computer system includes a processor set, one or more computer-readable storage media, and program instructions stored on the one or more storage media to cause the processor set to perform any combination of features of the foregoing methodology. Similar technical effects are obtained.

A method, according to one approach, includes receiving, by a first recipient at a first location, a first portion of a prepared stream of entangled particle pairs, where the first portion includes a first particle of a first of the entangled particle pairs and a first particle of a second of the entangled particle pairs. The method further includes detecting first measurement results of the first particle of the first entangled particle pair and first measurement results of the first particle of the second entangled particle pair. The method further includes identifying, within a predetermined playbook of the first recipient, a first entry that is associated with the first measurement results of the first particle of the first entangled particle pair and the first measurement results of the first particle of the second entangled particle pair. A first action paired with the first entry is performed by the first recipient. A second particle of the first entangled particle pair is received by a second recipient at a second location, where a second particle of the second entangled particle pair is received by the second recipient at the second location. The first action includes waiting to receive a transmission from the second recipient to cause a synchronous transaction between the first recipient and the second recipient.

A technical effect of using entangled particles of a prepared stream of entangled particle pairs to identify an action for a recipient to perform includes mitigating the occurrence of lag within communication across relatively large distances. Another technical effect of using entangled particles of a prepared stream of entangled particle pairs to identify an action for a recipient to perform includes communication across relatively large distances without a dependance on an atomic clock. More specifically, by not depending on an atomic clock, delays and errors that would otherwise be present (based on an accuracy of a given atomic clock changing based on nearby relatively large masses) are mitigated from communication transmission operations. Furthermore, a technical effect of a first recipient waiting to receive a transmission from a second recipient includes the enablement of a synchronous transaction between recipients that are separated by relatively large distances.

A technical use case environment of the foregoing methodology includes the first recipient being a spacecraft and/or land based receiver and the second recipient being a spacecraft and/or land based receiver, where the recipients are located relatively large distances from one another (>=1200 km). Furthermore, the prepared stream of entangled particle pairs may be prepared on and transmitted by a spacecraft in outer space, where the recipients are each located relatively large distances from the transmitting spacecraft.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as action synchronization code of block 150 for action synchronization of different recipients of entangled particle pairs. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

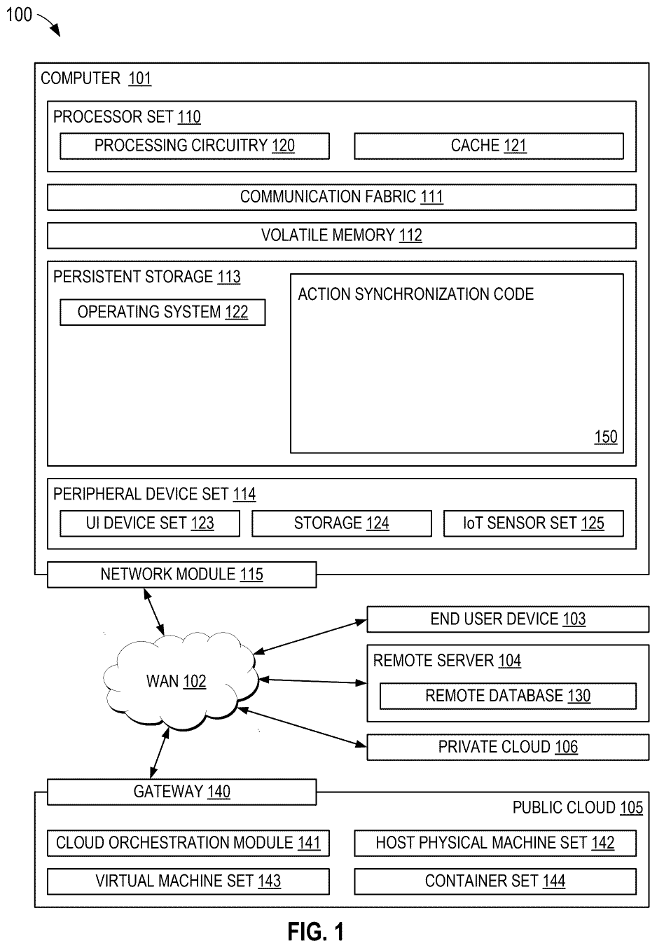

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere above, as exploration of outer space broadens (the distance between Earth and a space exploring craft increases) space technology faces a multitude of challenges and issues that remain to be resolved. Some of these challenges and issues are based on the coordination of activities by parties who are separated by relatively large distances, e.g., distances measured in terms of light-seconds and greater. Conventional solutions to these issues experience delay that is times equal to two times the light-distance between the communicating parties, e.g., an Earth based ground station and a space exploration craft.

These challenges and issues highlight a need for a solution to address the coordination of activities by parties who are separated by relatively large distances. The techniques of approaches described herein mitigate the challenges and issues described above by using quantum entanglement to coordinate the actions of two parties separated by relatively large distances.

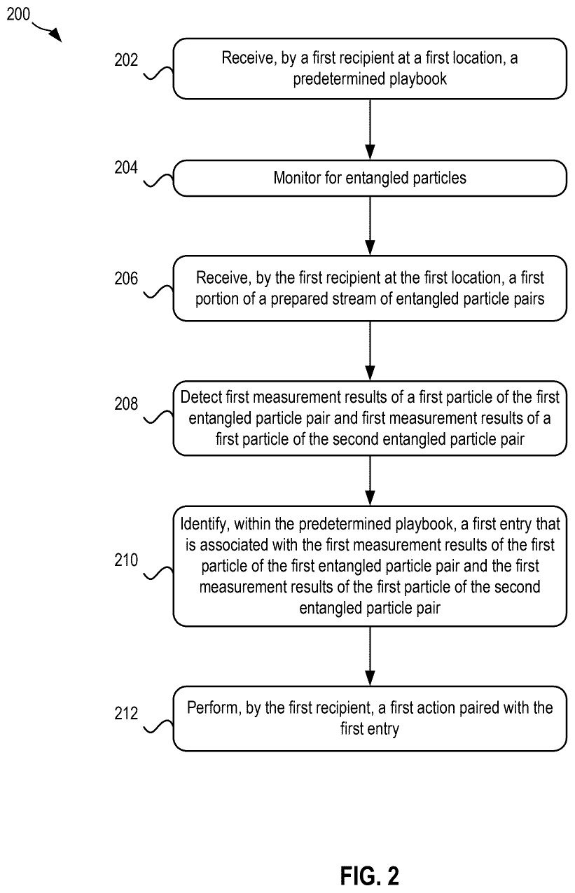

Now referring to FIG. 2, a flowchart of a method 200 is shown according to one approach. The method 200 may be performed in accordance with aspects of the present invention in any of the environments depicted in FIGS. 1-5, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes receiving, by a first recipient at a first location, a predetermined playbook. For context, the recipients described herein, e.g., a first recipient at a first location and a second recipient at a second location that is different than the first location, may, in some approaches, be user devices. These recipients may be separated by any amount of distance. In some preferred approaches, the recipients are separated by relatively large distances.

These recipients may include processing circuits that are each respectively configured to perform operations of the techniques described herein. Furthermore, the recipients are additionally, in some preferred approaches, configured to detect (via monitoring) and/or measure at least a portion of a prepared stream of entangled particle pairs.

The predetermined playbook of the first recipient is, in some preferred approach, prepared and output to at least the first recipient by a transmitting device. Another predetermined playbook, e.g., a predetermined playbook of a second recipient, may additionally and/or alternatively be prepared by the transmitting device and be output to, and received by the second recipient. In some approaches, the transmitting device is a spacecraft that is in outer space at a third location, which may be at least some distance from the first recipient and at least some distance from the second recipient. In such an approach, at least one of the recipients may be located at a location on a planet. In other approaches, at least one of the locations of the recipients may be a location that lies along an orbital path of the recipient around a planet and/or space element (such as an asteroid). In some other approaches, at least one of the recipients may be located in and/or traveling across interstellar space. In some other approaches, the transmitting device may be a ground based component that is located on the surface of a planet at a third location, e.g., the surface of Earth, the surface of Mars, etc. In another approach, the location of the first recipient may include a surface of a planet. In yet further approaches, the location of the first recipient may include an atmosphere of a planet, e.g., wherein the first recipient is traversing in Earth's atmosphere. It should be noted that the distances between the recipients and the transmitting device may change over time, e.g., based on orbits, based on interstellar movement by one or more of the recipients and/or the transmitting device, etc.

The predetermined playbook(s), in some preferred approaches, are transmitted to the recipients using techniques that would become apparent to one of ordinary skill in the art after reading the descriptions herein. In some approaches, the different predetermined playbooks may include the same contents, e.g., a copy of one another. In some other approaches, the predetermined playbooks may include at least some different contents and some matching contents. In yet some other approaches, the predetermined playbooks may include entirely different contents. For example, depending on the approach, these different versions and/or playbooks may include a plurality of entries, and a plurality of actions paired with one or more of the entries, as will be described in greater detail elsewhere herein.

In response to receiving the predetermined playbook of the first recipient, the first recipient preferably monitors for entangled particles, e.g., see operation 204. In some preferred approaches, the entangled particles are included in a first portion of a prepared streams of entangled particle pairs. More specifically, in some approaches, the first portion of the prepared streams of entangled particle pairs includes half of the particles of the entangled particle pairs that are transmitted by the transmitter to the first recipient. Meanwhile, a second portion of the prepared streams of entangled particle pairs, in some approaches, includes the other half of the particles of the entangled particle pairs that are transmitted by the transmitter to the second recipient. These entangled particle pairs may be sent by the transmitter to the first recipient and the second recipient in the different portions of the prepared stream.

The first recipient and/or other recipients may use monitoring techniques that would become apparent to one of ordinary skill in the art after reading the descriptions herein. Accordingly, the recipients preferably include monitoring components, e.g., signal detectors, atomic particle detectors, etc., of a type that would become apparent to one of ordinary skill in the art after reading the descriptions herein.

The monitoring may, in some approaches, be performed ongoingly. This monitoring may be particularly useful for approaches in which the transmitting device distributes (transmits) a constant stream of respective portions of entangled particle pairs to the separated recipients, e.g., bombarding broadcasts. In some other approaches, the monitoring may be performed at predetermined intervals, e.g., periodically over a predetermined period of time. In some other approaches, the playbook(s) may specify when to perform the monitoring and/or how often to perform the monitoring.

Operation 206 includes receiving, by the first recipient at the first location, a first portion of a prepared stream of entangled particle pairs, where the first portion includes at least a first particle of a first of the entangled particle pairs and a first particle of a second of the entangled particle pairs. In some preferred approaches, for each particle of an entangled particle pair that the first recipient receives, the second recipient also receives an associated entangled particle that, based on the nature of entangled particles, has a matching particle orientation.

The prepared stream of entangled particle pairs is, in some approaches, prepared by the transmission device that sends the playbook(s) to the recipients. After being prepared, the transmission device, in some approaches, transmits the first portion of the prepared stream to the first recipient, and transmits the second portion of the prepared stream to the second recipient. In some approaches, the stream of entangled particle pairs is prepared on and transmitted by a spacecraft in outer space. Because each of the recipients preferably receives one of the particles of each entangled particle pair of the prepared stream, the recipients are able to perform measurements on the received particles, resulting in measurement results that may be detected and read off sensors of the recipients. More specifically, in some approaches, the measurement performed includes performing a measurements to determine orientations of the received particles. For context, during preparation of the stream and transmission of the stream, the transmitter cannot control the orientation of the particles, but the orientations of the particles of entangled particle pairs are ensured by nature to match once entangled. In some approaches, the possible orientations of the particles may include a zero degree orientation, a forty-five degree orientation, a ninety degree orientation, a one-hundred and eighty degree orientation, etc. Accordingly, a reading performed by the first recipient for the first entangled particle of a first entangled particle pair of the prepared stream matches a reading performed by the second recipient for the second entangled particle of the first entangled particle pair of the prepared stream. Furthermore, a reading performed by the first recipient for the first entangled particle of a second entangled particle pair of the prepared stream matches a reading performed by the second recipient for the second entangled particle of the second entangled particle pair of the prepared stream, and so on and so forth.

Operation 208 includes detecting first measurement results of the first particle of the first entangled particle pair and first measurement results of the first particle of the second entangled particle pair. For context, for the first recipient, the first measurement results of the first particle of the first entangled particle pair may include a single orientation of the first particle of the first entangled particle pair for approaches in which different entangled particles of a first entangled particle pair of the prepared stream are transmitted from the transmitter to the recipients, e.g., a first particle of the first entangled particle pair to the first recipient and a second particle of the first entangled particle pair to the second recipient. A plurality of measurement results that are detected by the first recipient form a sequence of measurement results for a sequence of the particles that are received.

A second particle of the first entangled particle pair is received by the second recipient at the second location and a second particle of the second entangled particle pair is received by the second recipient at the second location. In response thereto, the second recipient detects first measurement results of the second particle of the first entangled particle pair and second measurement results of the second particle of the second entangled particle pair. More specifically, for the second recipient, the measurement results of the second particle of the first entangled particle pair may include a single orientation of the second particle of the first entangled particle pair.

The prepared stream preferably includes a plurality of entangled particle pairs, where half of the particles of each of the entangled particle pairs are transmitted by the transmitter to the first recipient as a first predetermined sequence of particles and the other half of the particles of each of the entangled particle pairs are transmitted by the transmitter to the second recipient as a second predetermined sequence of particles. A predetermined sequence of particles, in some approaches, may be set to occur with a known probability based on a predetermined time being caused between different transactions of measuring particles and performing actions in response thereto, as will now be described in greater detail below. These sequences may be of a known length of particles, which may be adjustable (as will be described in greater detail elsewhere herein). For example, although various operations of method 200 are based on a sequence of two particles of two entangled particle pairs being received by the first recipient, and a sequence of two other particles of the two entangled particle pairs being received by the second recipient, the number of particles that make up a sequence may depend on the approach.

Operation 210 includes identifying, within the predetermined playbook of the first recipient, a first entry that is associated with the first measurement results of the first particle of the first entangled particle pair and the first measurement results of the first particle of the second entangled particle pair. In some approaches, the identifying, within the predetermined playbook of the first recipient, the first entry that is associated with the first measurement results of the first particle of the first entangled particle pair and the first measurement results of the first particle of the second entangled particle pair includes measuring an orientation of the first particle of the first entangled particle pair and measuring an orientation of the first particle of the second entangled particle pair. For example, in one illustrative approach, the orientation of the first particle of the first entangled particle pair may be zero degrees. A lookup may additionally and/or alternatively be performed within the predetermined playbook of the first recipient for an entry pre-associated with orientations that match the measured orientations of the first particle of the first entangled particle pair and the first particle of the second entangled particle pair. For example, with continued references to the illustrative approach above in which the orientation of the first particle of the first entangled particle pair is zero degrees, an entry may be identified that is pre-associated with particles of entangled particle pairs identified to have measurement results that include a zero degree orientation. The orientation of the first particle of the second entangled particle pair may be the same or different than the orientation of the first particle of the first entangled particle pair.

A technical effect of measuring orientations of particles of an entangled particle pair includes the facilitation of synchronized communication operations between recipients of the particles. In order to enable these synchronized communication operations, in some approaches, actions may be pre-paired with at least one entry within a predetermined playbook. This way, in some approaches, once an entry in the predetermined playbook is identified, an action paired with the identified entry may also be identified and performed knowing that a second recipient, that measures a second particle of the entangled particle pair, is also performing an action to establish the synchronized communication operation. For example, a first action paired with the first entry is performed by the first recipient, e.g., see operation 212.

A technical effect of using entangled particles of a prepared stream of entangled particle pairs to identify an action for a recipient to perform includes mitigating the occurrence of lag within communication across relatively large distances. More specifically, the use of entangled particles of a prepared stream of entangled particle pairs avoids light-lag over these relatively large distances. Within the context of LEO satellites, these technical effects mitigate light lag across distances of around 1200 kilometers (km), which otherwise amounts to a lag time of about 0.004 seconds. Within the context of distances between Earth and Earth's moon, these technical effects mitigate light lag across distances of around 356,500 km to 406,700 km, which otherwise amounts to a lag time of about 1.189 to 1.356 seconds. Furthermore, within the context of distances between Earth and Mars, these technical effects mitigate light lag across distances of around 54.6M km-401M km, which otherwise amounts to a lag time of about 3.03 minutes to 22.3 minutes. These technical effects further includes secured communications in that the system has no knowledge of what is contained in playbook pairs, which ultimately allows synchronization to be offered as a service. Yet furthermore, a technical effect of using entangled particles of a prepared stream of entangled particle pairs to identify an action for a recipient to perform includes communication across relatively large distances without a dependance on an atomic clock. More specifically, by not depending on an atomic clock, delays and errors that would otherwise be present (based on an accuracy of a given atomic clock changing based on nearby relatively large masses) are mitigated from communication transmission operations.

In some approaches, identifications are only made in the predetermined playbook of the first recipient in response to a determination that a predetermined sequence of measurement results has been detected. For example, method 200, in some approaches, includes determining whether a predetermined sequence of measurement results is detected. For example, a first of the predetermined sequence of measurement results may include the first measurement results of the first particle of the first entangled particle pair and the first measurement results of the first particle of the second entangled particle pair. In such an approach, the first entry is identified within the predetermined playbook of the first recipient in response to a determination that the first predetermined sequence of measurement results has been detected.

A technical effect of conditionally triggering use of a predetermined playbook based on a predetermined sequence of measurement results being obtained includes reducing a processing workload of the first recipient. More specifically, the predetermined playbook of the first recipient is not prematurely analyzed by the first recipient subsequent to receiving a single entangled particle of an entangled particle pair. Instead, a scope of entries is first defined by identification of a predetermined sequence to reduce a scope of the entries of the predetermined playbook of the first recipient that is analyzed.

The types of actions that are included in the playbooks and, in some approaches, performed once identified based on measurement results, may depend on use cases of environments in which the recipients are deployed. In one approach, the actions of at least one of the playbooks described herein may include the recipient syncing to a local time signal. The actions of at least one of the playbooks described herein may additionally and/or alternatively include auditing statuses of equipment of the first recipient. In yet another approach, the actions of at least one of the playbooks described herein may include generating a report, e.g., such as an incident report for processing of entangled particles of the prepared stream, a report detailing data obtained by observations and readings performed by the first recipient while exploring one or more portions of outer space, a report detailing device health of components of the first recipient, a report detailing actions that are scheduled to be performed by the first recipient, etc.

A technical effect of using a predetermined playbook with a plurality of different actions includes a diversification of the potential synchronized operations that are able to be performed between different recipients across relatively large distances.

In some preferred approaches, at least some of the actions in the predetermined playbook of the first recipient may be associated with some of the actions in the predetermined playbook of the second recipient. For context, this association may be defined as actions that are related to one another in that they are to be performed together to achieve a task, but where the associated actions are not necessarily the same action. For example, in some approaches, the first action (in the first predetermined playbook used by the first recipient at the first location) may include waiting to receive a transmission from the second recipient (using the predetermined playbook of the second recipient) at the second location to cause a synchronous transaction between the first recipient and the second recipient.

A technical effect of a first recipient waiting to receive a transmission from a second recipient includes the enablement of a synchronous transaction between recipients that are separated by relatively large distances.

In order to ensure that the transmission is sent from the second recipient while the first recipient is waiting to receive the transmission, an action of the predetermined playbook of the second recipient may be associated with but different than some of the actions in the predetermined playbook of the first recipient. The predetermined playbook of the second recipient may include a second entry that is associated with first measurement results of the second particle of the first entangled particle pair and first measurement results of the second particle of the second entangled particle pair. An action to be performed by the second recipient (hereafter also referred to as the “second action”) may be paired with the second entry, where the second action includes the second recipient transmitting the transmission to the first recipient. This way, because the first particle and the second particle of the first entangled particle pair have the same orientation and because the first particle and the second particle of the second entangled particle pair have the same orientation, the second recipient performs an action including transmitting the transmission to the first recipient (in response to the second recipient receiving, at the second location that is different than the first location, the second particle of the first entangled particle pair) while the first recipient is performing a synchronized action that includes waiting to receive the transmission from the second recipient.

A technical effect of causing different recipients to use different predetermined playbooks includes the enablement of a synchronous transaction between recipients that are separated by relatively large distances. More specifically, by having different predetermined playbooks, different but synchronous actions are performed by different recipients based on measurement results of a sequence of the particles of an entangled particle pair matching. These different synchronous actions amount to a synchronous communication operation.

In some approaches, the first action is also paired with a second entry within the predetermined playbook of the first recipient, where the second entry within the predetermined playbook of the first recipient is not associated with the first measurement results of the first particle of the first entangled particle pair and the first measurement results of the first particle of the second entangled particle pair. For context, as mentioned elsewhere above, during preparation of the stream and transmission of the stream, the transmitter cannot control the orientation of the particles. For this reason, the transmitter can thereby not control the orientation of the particles of an entangled particle pair at the time measurements are performed by recipients on the particles. In order to combat this and increase a probability that a given one of the actions (e.g., such as waiting to receive a transmission from the second recipient) is performed by the first recipient, in some approaches, more than one of the entries (and up to all) of the entries of the predetermined playbook of the first recipient may be paired with the first action. This way, regardless of different potential measurement results of the first particle of the first entangled particle pair and/or different potential measurement results of the first particle of the second entangled particle pair, the first action is still ensured to be performed. Accordingly, the second entry within the predetermined playbook of the first recipient may, in some approaches, be associated with second measurement results of the first particle of the first entangled particle pair and second measurement results of the first particle of the second entangled particle pair to increase a probability that measurement results of the first particle of the first entangled particle pair and measurement results of the first particle of the second entangled particle pair (or other measurement results of any of the particles of the first portion of the prepared stream of entangled particle pairs) result in the first action being performed.

A technical effect of pairing an action with multiple entries in a predetermined playbook includes increasing a probability that the given action is performed. More specifically, because the orientation of the particles of the first entangled particle pair cannot be controlled, pairing the first action to multiple different measurement results increases a probability that the first action is performed.

More than one action may, in some approaches, be paired with a given entry of a predetermined playbook. For example, in one or more of such approaches, a second action, which is a different action than the first action, may be paired with the first entry within the predetermined playbook of the first recipient. In some approaches, each of the actions paired with an entry are performed in response to the entry being identified as being associated with measurement results of a sequence of particles of entangled particle pairs of the first portion of the prepared stream. For example, method 200 may include performing, by the first recipient, the first action paired with the first entry and performing the second action paired with the first entry in response to first entry being identified as being associated with detected measurement results of particles of a sequence. In some approaches, one or more of the actions that are prioritized to be performed may be paired with each of the entries of the predetermined playbook. In some other approaches, only a subset of the actions paired with an entry are performed in response to the entry being identified as being associated with measurement results of particles of a sequence, e.g., round-robin fashion, a random one of the actions paired with the entry, etc.

A technical effect of pairing multiple actions with a given entry includes increasing an output of the recipient for each particle of an entangled particle pair that is processed.

It should be noted that, in some approaches, a particle of an entangled particle pair of the prepared stream may be transmitted and, for some reason, not be received by one of the recipients. For example, during a monitoring session, a particle of an entangled particle pair may not be received based on the particle being intercepted, e.g., colliding with dust, being blocked by an unauthorized bad actor, etc. A determination may, in some approaches, be made that the particle is not received. For example, a determination may be made that the particle has not been received based on no particles being detected within a predetermined monitoring session. In response to such a determination, error correction and/or transaction buffers and rollbacks of a type that would become apparent to one of ordinary skill in the art after reading the descriptions herein may be performed as a recovery solution. In some other approaches, in response to such a determination, a predetermined default one of the actions of a predetermined playbook of the recipient that did not receive the particle may be performed, e.g., waiting to receive a transmission from a second recipient. In yet some other approaches, a remainder of a sequence may be identified (based on other particles of a predetermined sequence being identified) and an associated action may be performed.

A technical effect of basing at least some entries in the predetermined playbook on a sequence of particles of entangled particle pairs includes the expansion of potential actions that can be performed by the recipients (based on the sequences further defining the measurement results).

In some approaches, a length of one or more of the predetermined sequences may be adjusted for tuning the likelihood and/or frequency of the playbook being triggered. For example, method 200, in some approaches, includes tuning a likelihood that the first entry is identified within the predetermined playbook of the first recipient. In order to tune the likelihood that the first entry is identified within the predetermined playbook of the first recipient, method 200 may include adjusting, within the predetermined playbook of the first recipient, a number of measurement results that are associated with the first entry. This adjustment may, in some approaches, include removing at least one of the measurement results associated with an entry. This adjustment may be performed to increase the likelihood of an associated action being performed. In contrast, this adjustment may, in some approaches, include adding at least one of the measurement results associated with an entry. This adjustment may be performed to decrease the likelihood of an associated action being performed.

A technical effect of adjusting a length of one or more of the predetermined sequences includes tuning the likelihood and/or frequency of the playbook being triggered. Furthermore, increasing a length of the predetermined sequences allows for additional unique entries to be added to the playbook.

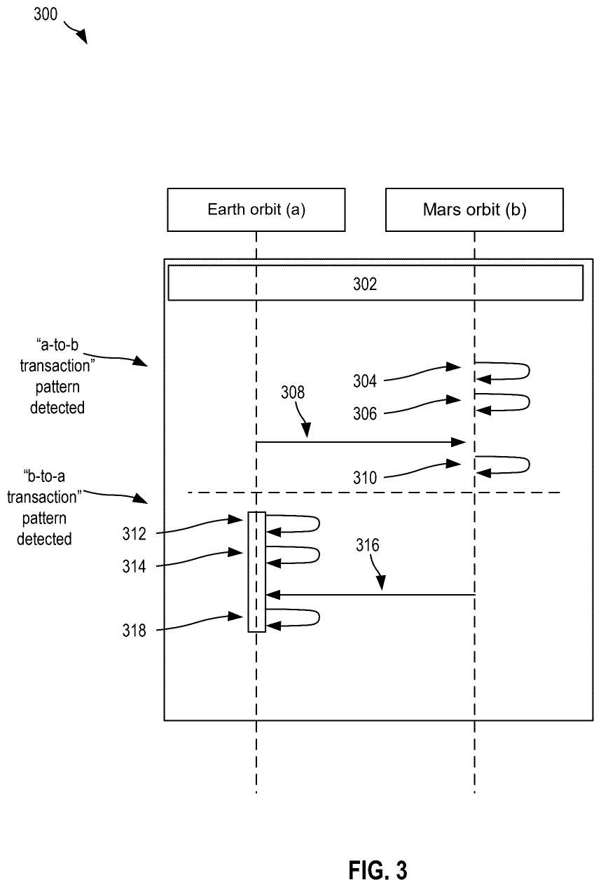

Now referring to FIG. 3, a flowchart of a method 300 is shown according to one approach. The method 300 may be performed in accordance with aspects of the present invention in any of the environments depicted in FIGS. 1-5, among others, in various approaches. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various approaches, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 includes similar operations to various operations of method 200, while the operations of method 300 are performed between a first recipient device orbiting Earth, e.g., see Earth orbit (a), and a second recipient device orbiting Mars, e.g., see Mars orbit (b).

Referring first to a first sub-portion of method 300 in which an “a-to-b transaction” pattern detected, method 300 includes a constant stream of entangled particles being distributed by a transmitter source, and received by the recipients, e.g., see operation 302. More specifically, a first portion of a prepared stream of entangled particle pairs is transmitted to and received by a first recipient and a second portion of the prepared stream of entangled particle pairs is transmitted to and received by a second recipient. In some approaches, entangled quantum particle pairs of the stream are measured, results are logged, and the sequence of results may form an identifiable pattern, e.g., a predetermined sequence.

With continued reference to the first sub-portion of method 300, operation 304 includes the second recipient beginning a transaction. For context, performance of the transaction is an action paired with an entry of a predetermined playbook of the second recipient, where the entry is identified as being associated with measurement results of at least two particles of the stream received by the second recipient. Thereafter, the second recipient waits for a transmission from the first recipient (to cause a synchronous transaction between the recipients), e.g., see waiting operation 306 and a transmission received from the first recipient in operation 308. In operation 310, the transaction between the recipients is optionally ended.

Referring next to a second sub-portion of method 300 in which an “b-to-a transaction” pattern detected, various operations that may be performed in response to the first recipient receiving a portion of entangled quantum particle pairs of the stream are shown in accordance with some approaches.

With continued reference to the second sub-portion of method 300, operation 312 includes the first recipient beginning a transaction. For context, performance of the transaction is an action paired with an entry of a predetermined playbook of the first recipient, where the entry is identified as being associated with measurement results of at least two particles of the stream received by the first recipient. Thereafter, the first recipient waits for a transmission from the second recipient (to cause a synchronous transaction between the recipients), e.g., see waiting operation 314 and a transmission received from the second recipient in operation 316. In operation 318, the transaction between the recipients is optionally ended.

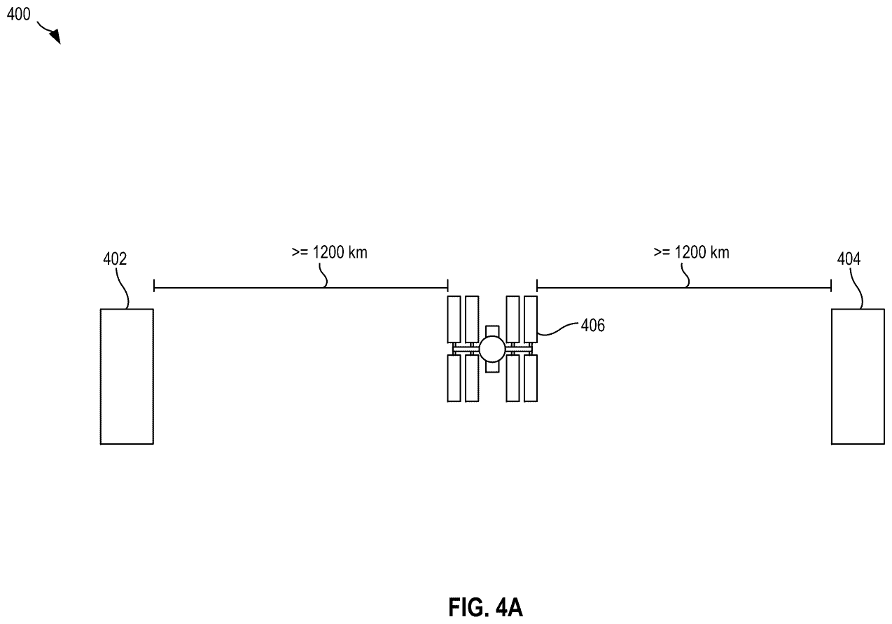

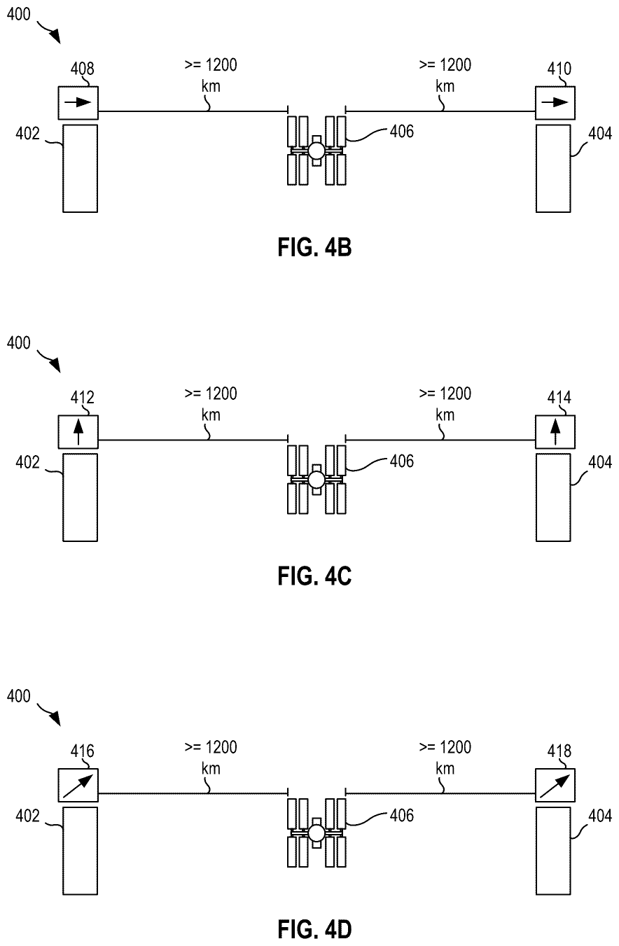

FIGS. 4A-4D depict a communication environment 400, in accordance with several approaches. As an option, the present communication environment 400 may be implemented in conjunction with features from any other approach listed herein, such as those described with reference to the other FIGS. Of course, however, such communication environment 400 and others presented herein may be used in various applications and/or in permutations which may or may not be specifically described in the illustrative approaches listed herein. Further, the communication environment 400 presented herein may be used in any desired environment.

Referring first to FIG. 4A, the communication environment 400 includes a transmission device 406 that is located between a first recipient 402 and a second recipient 404. The recipients are located relatively large distances from one another and the transmission device, e.g., see “>=1200 km”.

In some approaches, each of the recipients are distributed different pre-arranged playbooks of potential actions. For example, a first playbook (received by the first recipient) may detail first actions for the first recipient to perform and a second playbook (received by the second recipient) may detail second actions for the second recipient to perform. In some approaches, each entry in the playbook may be paired with an action that will be coordinated. For context, this action may, in some approaches, be embodied in a short program, e.g., send a message about a financial transaction, market close/open, wait a period based on light lag or transmission latency, etc. In some approaches, each entry in the playbook may additionally and/or alternatively be paired with a pattern consisting of a sequence of any number greater than one of quantum measurements, e.g., an associated measurement result. Each entry in the playbook may additionally and/or alternatively be paired with a calculated probability of the occurrence of a given sequence. In some other approaches, each entry in the playbook may additionally and/or alternatively be paired with probabilities of actions that are used to categorize actions that are desired to be taken at given time intervals, from a relatively very short time interval between coordinated actions (high probability of a pattern match) to a relatively very long time interval between coordinated actions (low probability of a pattern match).

In some approaches, prepared stream of entangled particle pairs may be constantly distributed to the recipients by the transmission device and received by the recipients, e.g., where a first portion of the prepared stream of entangled particle pairs is ongoingly transmitted to and received by the first recipient and a second portion of the prepared stream of entangled particle pairs is ongoingly transmitted to and received by the second recipient. In some approaches, particles of entangled particle pairs of the prepared stream are measured by the recipients. The measurement may be performed at the same time, e.g., such as where the particles are received by the recipients at the same time. In some other approaches, the measurements may be performed at a predetermined time within a predetermined sampling period known to the recipients. For example, in some approaches, each recipient receives a different particle of an entangled particle pair and performs a measurement. In some approaches in which sequences of particles are transmitted to the recipients, in response to a determination that a pattern from the playbook is detected (by either party) an action paired with the identified entry is performed. This action may be performed by one of the recipients knowing that the other counterpart recipient that is separated at a relatively great distance also is able to make the same measurement and thereby also makes a pre-arranged action. In some preferred approaches, the action facilitates communication and/or a transmission to the other party, and/or a local action.

Referring now to FIGS. 4B-4D, different measurement results of particles of entangled particle pairs within the prepared stream of entangled particle pairs are shown. For example, in FIG. 4B, measurement results 408 and 410 depict measured polarizations of ninety degrees. Entries (and actions paired with the entries) may be identified in the predetermined playbooks (identified based on the measurement results) for the recipients to perform. Referring now to FIG. 4C, measurement results 412 and 414 depict measured polarizations of zero degrees. Entries (and actions paired with the entries) may be identified in the predetermined playbooks (identified based on the measurement results) for the recipients to perform. Referring now to FIG. 4D, measurement results 416 and 418 depict measured polarizations of forty-five degrees. Entries (and actions paired with the entries) may be identified in the predetermined playbooks (identified based on the measurement results) for the recipients to perform.

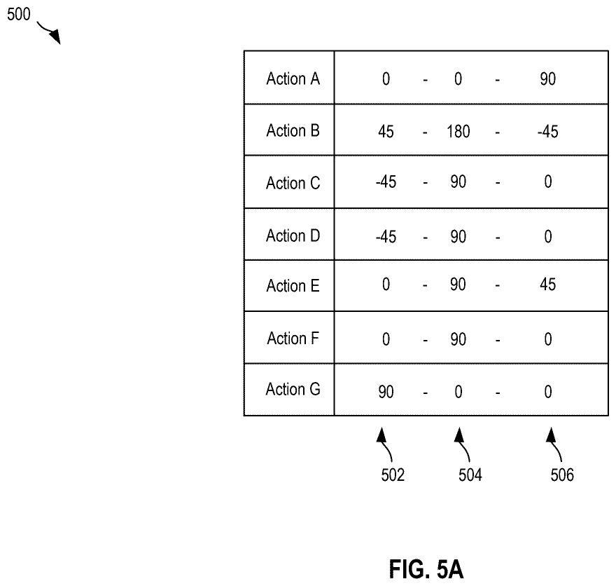

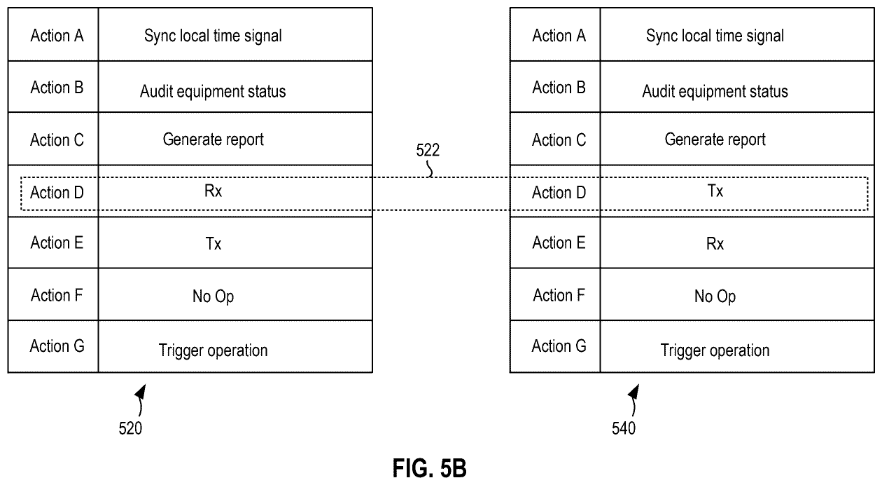

FIGS. 5A-5B depict tables 500, 520 and 540 of playbooks, in accordance with several approaches. As an option, the present tables 500, 520 and 540 may be implemented in conjunction with features from any other approach listed herein, such as those described with reference to the other FIGS. Of course, however, such tables 500, 520 and 540 and others presented herein may be used in various applications and/or in permutations which may or may not be specifically described in the illustrative approaches listed herein. Further, the tables 500, 520 and 540 presented herein may be used in any desired environment.

Referring first to FIG. 5A, the table 500 may be included in each of the playbooks distributed to a first recipient and a second recipient. The table 500 includes a plurality of entries that list actions for measurement results of particles of entangled particle pairs of a prepared stream of entangled particle pairs. For example, a first column of the table includes first measurement results 502 that detail potential orientations that may be measured by the recipients for particles of a first entangled particle pair that are received by the recipients. A second column of the table includes second measurement results 504 that detail potential orientations that may be measured by the recipients for particles of a second entangled particle pair that are received by the recipients. A first column of the table includes third measurement results 506 that detail potential orientations that may be measured by the recipients for particles of a third entangled particle pair that are received by the recipients. These three measurement results, when measured by the recipients within a prepared stream, establish a sequence which may be used to identify an action to perform, e.g., see Action A-Action G.

Referring now to FIG. 5B, the tables 520 and 540 may be used to define an action identified in the table 500. For example, in response to identifying that action “D” is to be performed (based on detecting “-45-90-0” degree orientations of a sequence of received particles of entangled particle pairs) the first recipient may use the table 520 to identify a first action that the first recipient is to perform, i.e., “Rx” which stands for waiting to receive a transmission from the second recipient. In contrast, the second recipient may use the table 540 to identify a second action that the second recipient is to perform, i.e., “Tx” which stands for transmitting a transmission to the second recipient. Accordingly, entries of the tables 520 and 540 are paired 522 to cause a synchronous transaction between the first recipient and the second recipient.

Some considerations that may be made when deploying the techniques described herein include that the distance between recipients (a source and a destination) may be equidistant (equal transmission times) or non-equidistant, depending on the approach. In the latter case, the playbook can account for the latency (light lag in the case of photons, particle travel time for sub-light particles like electrons), and the transmission lag at runtime can be an input variable and/or computed according to a formula. Furthermore, it should be noted that these techniques are non-obvious with respect to conventional communication techniques, and particularly communication techniques that involve one time pads, because here the participants of communication do not have to know which pads have been used, and instead fresh particles are used every prepared stream. Another consideration is that sequences in playbooks are preferably unique and cover the space of possible actions. More specifically, relatively more common actions can have shorter (e.g. more frequent) identifiers.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
receiving, by a first recipient at a first location, a first portion of a prepared stream of entangled particle pairs, the first portion including a first particle of a first of the entangled particle pairs and a first particle of a second of the entangled particle pairs;
detecting first measurement results of the first particle of the first entangled particle pair and first measurement results of the first particle of the second entangled particle pair;
identifying, within a predetermined playbook of the first recipient, a first entry that is associated with the first measurement results of the first particle of the first entangled particle pair and the first measurement results of the first particle of the second entangled particle pair; and
performing, by the first recipient, a first action paired with the first entry.

2. The method of claim 1, wherein a second particle of the first entangled particle pair is received by a second recipient at a second location, wherein a second particle of the second entangled particle pair is received by the second recipient at the second location, wherein the first action comprises waiting to receive a transmission from the second recipient to cause a synchronous transaction between the first recipient and the second recipient.

3. The method of claim 2, wherein a predetermined playbook of the second recipient includes a second entry that is associated with first measurement results of the second particle of the first entangled particle pair and first measurement results of the second particle of the second entangled particle pair, wherein a second action to be performed by the second recipient is paired with the second entry, wherein the second action includes the second recipient transmitting the transmission to the first recipient.

4. The method of claim 1, wherein the identifying, within the predetermined playbook of the first recipient, the first entry that is associated with the first measurement results of the first particle of the first entangled particle pair and the first measurement results of the first particle of the second entangled particle pair comprises: measuring an orientation of the first particle of the first entangled particle pair; measuring an orientation of the first particle of the second entangled particle pair; and performing a lookup within the predetermined playbook of the first recipient for an entry pre-associated with orientations that match the measured orientations of the first particle of the first entangled particle pair and the first particle of the second entangled particle pair.

5. The method of claim 1, wherein the first action is also paired with a second entry within the predetermined playbook of the first recipient, wherein the second entry within the predetermined playbook of the first recipient is not associated with the first measurement results of the first particle of the first entangled particle pair and the first measurement results of the first particle of the second entangled particle pair, wherein the second entry within the predetermined playbook of the first recipient is associated with second measurement results of the first particle of the first entangled particle pair and second measurement results of the first particle of the second entangled particle pair.

6. The method of claim 1, wherein a second action is paired with the first entry, wherein the second action is selected from the group consisting of: syncing to a local time signal, auditing statuses of equipment of the first recipient, and generating a report, and further comprising: performing, by the first recipient, the second action paired with the first entry.

7. The method of claim 1, further comprising:
receiving, by the first recipient, the predetermined playbook of the first recipient; and
in response to receiving the predetermined playbook of the first recipient, monitoring for entangled particles,
wherein the first location lies along an orbital path of the first recipient around a planet.

8. The method of claim 1, wherein the first location is selected from the group consisting of: interstellar space, a surface of a planet, and Earth's atmosphere, wherein the prepared stream of entangled particle pairs is prepared on and transmitted by a spacecraft in outer space.

9. The method of claim 1, further comprising:
determining whether a predetermined sequence of measurement results is detected,
wherein a first of the predetermined sequence of measurement results includes the first measurement results of the first particle of the first entangled particle pair and the first measurement results of the first particle of the second entangled particle pair,
wherein the first entry is identified within the predetermined playbook of the first recipient in response to a determination that the first predetermined sequence of measurement results has been detected.

10. The method of claim 1, further comprising:
tuning a likelihood that the first entry is identified within the predetermined playbook of the first recipient,
wherein the tuning the likelihood that the first entry is identified within the predetermined playbook of the first recipient includes:
adjusting, within the predetermined playbook of the first recipient, a number of measurement results that are associated with the first entry.

11. A computer program product comprising:
one or more computer-readable storage media; and
program instructions stored on the one or more storage media to perform operations comprising:
receiving, by a first recipient at a first location, a first portion of a prepared stream of entangled particle pairs, the first portion including a first particle of a first of the entangled particle pairs and a first particle of a second of the entangled particle pairs;
detecting first measurement results of the first particle of the first entangled particle pair and first measurement results of the first particle of the second entangled particle pair;
identifying, within a predetermined playbook of the first recipient, a first entry that is associated with the first measurement results of the first particle of the first entangled particle pair and the first measurement results of the first particle of the second entangled particle pair; and
performing, by the first recipient, a first action paired with the first entry.

12. The computer program product of claim 11, wherein a second particle of the first entangled particle pair is received by a second recipient at a second location, wherein a second particle of the second entangled particle pair is received by the second recipient at the second location, wherein the first action comprises waiting to receive a transmission from the second recipient to cause a synchronous transaction between the first recipient and the second recipient.

13. The computer program product of claim 11, wherein the identifying, within the predetermined playbook of the first recipient, the first entry that is associated with the first measurement results of the first particle of the first entangled particle pair and the first measurement results of the first particle of the second entangled particle pair comprises: measuring an orientation of the first particle of the first entangled particle pair; measuring an orientation of the first particle of the second entangled particle pair; and performing a lookup within the predetermined playbook of the first recipient for an entry pre-associated with orientations that match the measured orientations of the first particle of the first entangled particle pair and the first particle of the second entangled particle pair.

14. The computer program product of claim 11, wherein the first action is also paired with a second entry within the predetermined playbook of the first recipient, wherein the second entry within the predetermined playbook of the first recipient is not associated with the first measurement results of the first particle of the first entangled particle pair and the first measurement results of the first particle of the second entangled particle pair, wherein the second entry within the predetermined playbook of the first recipient is associated with second measurement results of the first particle of the first entangled particle pair and second measurement results of the first particle of the second entangled particle pair.

15. The computer program product of claim 11, wherein a second action is paired with the first entry, wherein the second action is selected from the group consisting of:
syncing to a local time signal, auditing statuses of equipment of the first recipient, and generating a report, and wherein the operations further comprise: performing, by the first recipient, the second action paired with the first entry.

16. The computer program product of claim 11, wherein the operations further comprise:
determining whether a predetermined sequence of measurement results is detected,
wherein a first of the predetermined sequence of measurement results includes the first measurement results of the first particle of the first entangled particle pair and the first measurement results of the first particle of the second entangled particle pair,
wherein the first entry is identified within the predetermined playbook of the first recipient in response to a determination that the first predetermined sequence of measurement results has been detected.

17. The computer program product of claim 11, wherein the operations further comprise:
tuning a likelihood that the first entry is identified within the predetermined playbook of the first recipient,
wherein the tuning the likelihood that the first entry is identified within the predetermined playbook of the first recipient includes:
adjusting, within the predetermined playbook of the first recipient, a number of measurement results that are associated with the first entry.

18. A computer system comprising:
a processor set;
one or more computer-readable storage media; and
program instructions stored on the one or more storage media to cause the processor set to perform operations comprising:
receiving, by a first recipient at a first location, a first portion of a prepared stream of entangled particle pairs, the first portion including a first particle of a first of the entangled particle pairs and a first particle of a second of the entangled particle pairs;
detecting first measurement results of the first particle of the first entangled particle pair and first measurement results of the first particle of the second entangled particle pair;
identifying, within a predetermined playbook of the first recipient, a first entry that is associated with the first measurement results of the first particle of the first entangled particle pair and the first measurement results of the first particle of the second entangled particle pair; and
performing, by the first recipient, a first action paired with the first entry.

19. The computer system of claim 18, wherein a second particle of the first entangled particle pair is received by a second recipient at a second location, wherein a second particle of the second entangled particle pair is received by the second recipient at the second location, wherein the first action comprises waiting to receive a transmission from the second recipient to cause a synchronous transaction between the first recipient and the second recipient.

20. The computer system of claim 18, wherein the identifying, within the predetermined playbook of the first recipient, the first entry that is associated with the first measurement results of the first particle of the first entangled particle pair and the first measurement results of the first particle of the second entangled particle pair comprises: measuring an orientation of the first particle of the first entangled particle pair; measuring an orientation of the first particle of the second entangled particle pair; and performing a lookup within the predetermined playbook of the first recipient for an entry pre-associated with orientations that match the measured orientations of the first particle of the first entangled particle pair and the first particle of the second entangled particle pair.
